(19) United States
(12) Patent Application Publication
(10) Pub. No.: US 2026/0206793 A1
(43) Pub. Date: Jul. 23, 2026

(54) METHOD FOR CONTROLLING THE PRODUCTION OF MEAT ANALOGUES BY WET EXTRUSION USING GAS

(71) Applicant: L'Air Liquide, Société Anonyme pour l'Etude et l’Exploitation des Procédés Georges Claude, Paris (FR)

(72) Inventors: Carlos AVILES, Versailles (FR); Christine KASTEN, Krefeld (DE); Marc SPORING, Krefeld (DE)

(21) Appl. No.: 19/455,961

(22) Filed: Jan. 22, 2026

(30) Foreign Application Priority Data
Jan. 22, 2025 (EP) 25153358

(51) Int. Cl. A23J 3/26; A23J 3/14; A23J 3/22; A23P 30/20

(52) U.S. Cl. CPC A23J 3/26; A23J 3/14; A23J 3/227; A23P 30/20

(57) ABSTRACT

A method for manufacturing processed food products based on plant proteins, by wet extrusion in an extrusion screw, using a gas in at least one zone of the screw, notably products considered to be animal meat analogues, characterized in that the injection of gas is controlled by regulating the volume of injected gas with respect to a desired setpoint value.

### CROSS REFERENCE TO RELATED APPLICATIONS

This application claims the benefit of priority under 35 U.S.C. § 119 (a) and (b) to European Patent Application No. 25153358.4, filed Jan. 22, 2025, the entire contents of which are incorporated herein by reference.

### BACKGROUND

The present invention relates to methods and devices for manufacturing processed food products based on plant proteins, by wet extrusion in an extrusion screw, using gas, the aim of the targeted products being to replace animal meat.

Whether of animal or plant origin, proteins offer many texturing, gelling and emulsifying functionalities.

The market is growing and suppliers are constantly innovating to explore new functionalities and applications.

Experts consider that the world demand for meat shall increase by about 30% by 2030, and it can already be noted that, over 50 years, meat consumption in the world has multiplied by 4 to reach 320 million tonnes: consumption of poultry has even multiplied by 8, that of pigs by 3 to 4 and that of ruminants (cattle and sheep) by 2.

To meet the growing needs of the farming world, the livestock feed sector is growing, thus promoting the volume growth of the protein market.

In this context, plant proteins are experiencing a clear revival of interest, in connection with concerns regarding sustainable development, and consumers are looking for both protein-enriched products and alternatives to meat: the industries producing plant proteins have thus made enormous advances in providing mixed products, or even 100% plant products, offering taste and visual qualities that can be described as equivalent.

However, it appears that producers of plant protein-based food products start from dehydrated proteins as raw materials and need to ensure, for the one part, the rehydration of these raw-material proteins, and, for the other part, the shaping of the final product, in a reliable and reproducible manner.

By way of illustration, soy-based “textured” or “texturized” vegetable proteins (TVPs) are produced from soy flour that is defatted, cooked under pressure and dehydrated. This results in a food that is extremely rich in protein, up to 50 g of protein per 100 g of dry product, considered tasty and inexpensive, and popular with vegetarians. TVPs are generally in the form of granules of varying size, and they assume a texture similar to ground beef after cooking. They can be seasoned in many ways.

In this context, the conventional basic recipe for manufacturing such products consists of a mixture of proteins (concentrate and/or isolate from one or more sources) and water.

The protein sources used may notably be the following: soy, peas, chickpeas, lentils, beans or other legumes, or a binary mixture or mixture of several different sources. Depending on the type of proteins used, plant fibres may be added. Recipes may also include oil, flavourings and colourings.

Meat analogues are products that mimic the texture, colour and taste of meat of animal origin. In general, this type of products are manufactured by wet extrusion from protein concentrates or isolates. This method uses high temperatures and high pressures to process a mixture of protein concentrate and water into a fibrous structure that resembles animal meat. One of the main challenges for the industry of meat analogues of plant origin is the presence of off-flavours such as earthy, herbaceous or beany notes. The literature nowadays agrees that a significant portion of these flavours are generated by the oxidation of unsaturated fatty acids present in the seeds used for the production of protein concentrates.

There are thus a good number of methods for reducing the amount of molecules that produce off-flavours, with varying efficiencies. Nevertheless, in all cases, varying amounts of unsaturated fatty acids remain in the composition of the protein concentrates. Under the conditions used during wet extrusion, oxidation is therefore accelerated, creating new compounds that can impact the taste of meat analogues.

In the wet extrusion step, off-flavour masking is the technique used to improve the taste of meat analogues. Flavour maskers can be added to the initial formulation, before extrusion. Alternatively, the meat analogues are soaked in a broth containing the masking agents and the flavourings used to provide the desired taste. In both cases, the addition of additives to the product formulation impacts the list of ingredients displayed on the product.

### SUMMARY

As will be seen in more detail hereinafter, the present invention is committed to proposing a solution constituting an aid to the formulation of meat analogues which makes it possible to reduce the amount of flavourings added. The solution consists in preventing the raw materials and the product being processed from making contact with ambient oxygen during wet extrusion.

Preferably, specifically, but this is only an advantageous option, it is advantageous for the raw material to have also been safeguarded from oxidation upstream by one or more of the following methods: oxygen control during extraction, storage under inert atmosphere, cold storage, or vacuum storage.

The extrusion screw used in such methods has a configuration that is different for each recipe and for each industrial site.

However, it can be considered that the screw is very often divided into three sections:
The first is used to receive the raw material, preheat it (generally below 100° C.), and convey it to the next section.
The second section is a mixing and cooking section in which the temperature is generally around 110-170° C. In this section, the proteins are denatured and sheared.
Lastly, in the third section, the mixture begins cooling (typically in the range 100-130° C.) and compression that forces the proteins to align to begin creating fibres. It is in this section that some prior art methods implement an injection of gas.
The mixture, which then has a semi-liquid consistency, is then transferred to a cooling mould or die in which the temperature is lowered to about 70° C., causing the proteins to align in the form of fibres and a solid texture to be created.

The experiments conducted by the applicant have demonstrated that it is advantageous to inject the gas into this third section, in order to obtain dispersion and avoid the counterflow of gas towards the preceding sections.

And as will be seen in more detail hereinafter, the present invention proposes to obtain better control of the injection of gas into such screws, and, for this purpose, it proposes to control the injection of gas not in terms of mass according to usual practice and according to what would appear to be a technical logic, but in terms of volume of gas.

The injected gas is advantageously measured, controlled, outside the extruder at what is referred to as an upstream measurement point. This gas comes from a gas source upstream of the extruder (for example a cylinder), in which it is at ambient temperature.

The measurements are carried out at this same upstream temperature, in order to then proceed to injection in a zone of the extruder.

Once in the extruder, the gas is heated to the temperature prevailing at the injection point. This change in temperature will cause the gas to expand.

Moreover, the pressure between the upstream measurement point and the injection point is also different.

The expansion of the gas is thus affected by these two factors: pressure and temperature.

The temperature is relatively constant at the injection point; for a given test, it can generally vary by 1 to 2 degrees. As for the pressure, it can vary frequently by a few bar depending on the scale of the equipment used, the recipe and the operating conditions.

Now, as is well known to those skilled in the art, the volume of gas, for example nitrogen, varies linearly with the temperature at a given pressure, whereas the volume of gas varies exponentially with the pressure for a given temperature.

And it is the merit of the present invention to understand that, when the pressure changes (the pressure inside the screw, at the injection point) from one extrusion operation to another under the same operating conditions, the level of aeration will also change for the same mass of injected gas.

And the present invention therefore proposes to regulate such an operation in terms of volume of gas and not in terms of mass, and thus ensure that the volume ratio of gas injected into the extruder remains the same throughout the method in spite of variations in temperature and pressure at the injection point.

Reference is made to “volume ratio” above, that is to say the ratio in terms of volume between the volume of proteinaceous product present in the screw and the volume of gas injected (measured/calculated/estimated) at the injection point.

And according to a preferred embodiment of the invention, the injected volume is not simply measured and regulated, but the pressure of the gas is continuously monitored at at least three different points of the method, that is to say before injection, at the injection point, and downstream of the injection, and likewise the temperature of the gas is monitored before injection, at the injection point, and downstream of the injection.

A data acquisition and processing system then automatically calculates the amount of gas to be injected in order to maintain the desired constant volume ratio.

It will be recalled that an extruder is conventionally made up of one or more extrusion screws and a shell that surrounds them. This shell is a double wall in which a heat transfer fluid, which serves to heat the product to be extruded, circulates.

The shell is divided at the same time into several blocks, which can also be called “sleeves”, which are distributed along the screw. It is therefore possible to regulate the temperature of each element, and it is also possible to modify the configuration of the screw (conveying elements, shear elements, compression elements, etc.).

Gas is injected, for example, through a pipe which passes through one of the blocks (elements) of the extruder shell and delivers the gas directly into the associated facing screw zone.

The temperature and the pressure are then measured at the injection point, and also in the preceding sleeve, and in the next sleeve, therefore upstream and downstream of the injection point.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 illustrates, by way of a schematic and partial sectional view, an example of an installation for extruding food products that is known to those skilled in the art; and

FIG. 2 illustrates, by way of a schematic and partial sectional view, an example of an installation suitable for the implementation of the invention.

### DETAILED DESCRIPTION OF THE PREFERRED EMBODIMENTS

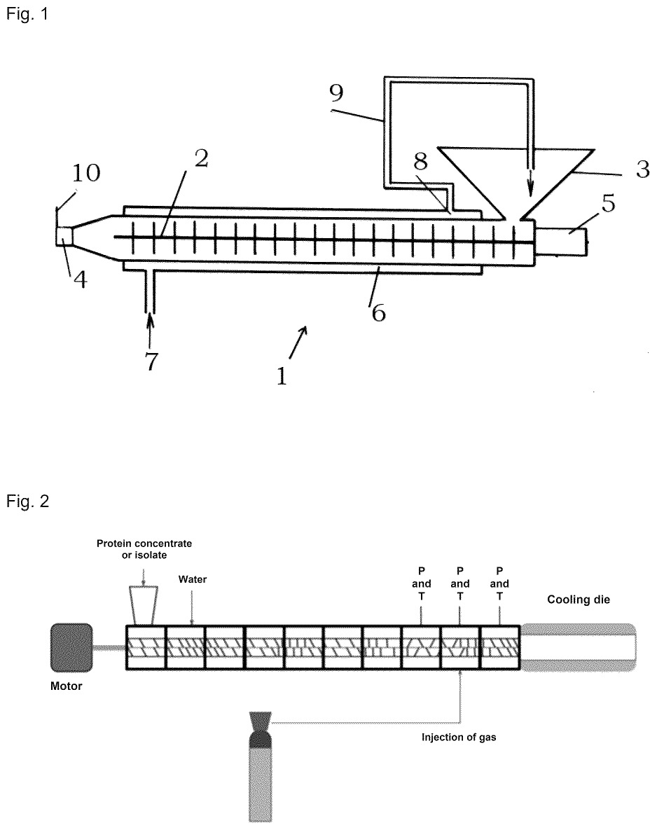

In FIG. 1, installation (1) consists of an extrusion screw (2), a feed hopper (3) and an outlet nozzle (4). The extrusion screw (2) is driven by a motor (5). The installation (1) also comprises a double shell (6) enveloping the extrusion screw (2). This double shell has an inlet orifice (7) for the cooling fluid, said fluid circulating all along the double shell around the extrusion screw to the outlet orifice (8) connected to a duct (9) allowing the cooling fluid to be reinjected in the feed hopper (9) onto the food product, thus allowing the cooling fluid to be recycled.

The installation further comprises here a cutting means (10) located at the outlet of the nozzle (4), allowing the extruded product formed to be cut into regular portions.

Using this cutting means, the operator can, by varying the cutting rate and/or the extrusion speed, prepare calibrated doses of food products. If the cutting rate is increased, the doses will be smaller, and if the cutting rate is decreased, the doses will be larger. Such a cutting means may notably be a cutting wire, a blade, a cleaver, scissors, a blade taper or any other means capable of producing a clean and quick cut of the food product formed, and notably a rotary knife whose blade brushes across the outlet nozzle of the extruder.

FIG. 2 shows the means for carrying out the measurements of the temperature and pressure of the gas in the shell: in the zone in which the gas is injected, and in the two zones of the shell preceding and following the zone in which the injection takes place.

The most used nozzle shapes are star, square, round, triangle, numbers, letters and other characters, but those skilled in the art are able to conceive of any other shape capable of meeting the demand of the end customer.

The double shell involves the combination of a first inner shell enveloping the extrusion screw or screws, one face of which is in direct contact with the food product, with a second outer shell that is concentric with the first so that a space is provided between the first and the second shell. Thus, the space provided between the two shells allows the circulation of a heating or cooling fluid. In this way, the fluid is not in direct contact with the food product, but in indirect contact via the inner shell.

As mentioned above, generally, the double shell has an inlet orifice, through which the fluid is introduced, and an outlet orifice through which the fluid is discharged or advantageously the fluid is recycled as outlined in [FIG. 1], either by reinjection into the double shell or by direct injection onto the food product in the feed hopper of the extruder. According to known embodiments, the extruder may comprise two, for example counter-rotating, extrusion screws.

The extrusion screw or screws may adopt a particular geometry, alternating, for example, portions of the “Archimedes” type, allowing the food product to advance towards the outlet of the extruder, and portions of the “mixer” type, allowing the food product to be mixed so that good homogenization of the product is obtained inside the extruder. Similarly, the mixing of the food product allows a better distribution of the temperature at the core of the product.

Similarly, some screws may optionally comprise a compression zone, that is to say, for example, a zone for progressively reducing the screw pitch or increasing the diameter of the screw shaft (for example, a diameter of the screw shaft increasing at constant screw pitch).

The present invention then relates to a method for manufacturing processed food products based on plant proteins, by wet extrusion in an extrusion screw, using a gas in at least one zone of the screw, notably products considered to be animal meat analogues, characterized in that the injection of gas is controlled by regulating the volume of injected gas with respect to a desired setpoint value.

According to one of the embodiments of the invention, the screw used is divided into three sections:
the first is capable of receiving the raw material, preheating it (generally below 100° C.), and conveying it to the next section;
the second section is a section capable of mixing and cooking the product, in which the temperature is typically around 110-170° C. In this section, the proteins are denatured and sheared;
lastly, in the third section, the mixture begins cooling (typically in the range 100-130° C.) and compression that forces the proteins to align to begin creating fibres;
the mixture, which then has a semi-liquid consistency, is then transferred to a downstream operation consisting of a cooling mould or die in which the temperature is lowered, for example to about 70° C., causing the proteins to align in the form of fibres and a solid texture to be created; and the injection of gas according to the invention being carried out in the third section.

The injected gas is advantageously measured, controlled, outside the extruder at what is referred to as an upstream measurement point. This gas comes from a gas source upstream of the extruder (for example a cylinder), in which it is at ambient temperature.

The measurements are carried out at this same upstream temperature, in order to then proceed to injection in a zone of the extruder.

While embodiments of this invention have been shown and described, modifications thereof may be made by one skilled in the art without departing from the spirit or teaching of this invention. The embodiments described herein are exemplary only and not limiting. Many variations and modifications of the composition and method are possible and within the scope of the invention. Accordingly, the scope of protection is not limited to the embodiments described herein, but is only limited by the claims which follow, the scope of which shall include all equivalents of the subject matter of the claims.

What is claimed is:

1. A method for manufacturing processed food products based on plant proteins, the products being considered to be animal meat analogues, the method comprising the step of
wet extruding a raw material referred to as a proteinaceous product in an extrusion screw, with injection of a gas in at least one zone, referred to as injection point, of the extrusion screw,
wherein the injection of the gas is controlled by regulating the volume of the injected gas with respect to a desired setpoint value, the desired setpoint being defined as a volume ratio between the volume of the proteinaceous product present in the extrusion screw and the volume of the gas injected at the injection point, the volume ratio being the same throughout the method in spite of temperature and pressure variations at the injection point.

2. The method according to claim 1, wherein the pressure of the gas is continuously monitored at at least three different points of the step, before injection into the extrusion screw, at the injection point, and downstream of the injection point.

3. The method according to claim 1, wherein the extrusion screw used is divided into three sections:
a first section capable of receiving the raw material, preheating it, and conveying it to the next section;
a second section capable of mixing and cooking the raw material and in which the temperature is preferably in the range 110-170° C.; and
a third section capable of cooling and compressing the raw material, a mixture from the third section, then having a semi-liquid consistency, is transferred to a downstream operation consisting of a cooling mould or die, said injection of gas being carried out in the third section of the extrusion screw.

4. The method according to claim 1, wherein the temperature of the gas is monitored at at least three different points of the step, before injection into the extrusion screw, at the injection point, and downstream of the injection point.

5. The method according to claim 1, wherein a data acquisition and processing system calculates the amount of the gas to be injected in order to maintain a desired gas volume ratio.
